(19) United States
(12) Patent Application Publication
(10) Pub. No.: US 2015/0271741 A1
(43) Pub. Date: Sep. 24, 2015

(54) Device Association Method, Apparatus, and System

(71) Applicant: Huawei Device Co., Ltd., Shenzhen (CN)

(72) Inventors: Xiaoxian Li, Shenzhen (CN); Zhiming Ding, Shenzhen (CN); Gaokun Pang, Shenzhen (CN)

(21) Appl. No.: 14/729,598

(22) Filed: Jun. 3, 2015

Related U.S. Application Data
(63) Continuation of application No. PCT/CN2013/088282, filed on Dec. 2, 2013.

(30) Foreign Application Priority Data
Dec. 4, 2012 (CN) 201210512787.0
Feb. 28, 2013 (CN) 201310066343.3

(51) Int. Cl. H04W 48/10; H04W 48/18; H04W 60/04; H04W 48/16

(52) U.S. Cl. CPC H04W 48/10; H04W 48/16; H04W 48/18; H04W 60/04; H04W 84/12

(57) ABSTRACT

Embodiments of the present invention provide a device association method, apparatus, and system, where the method includes: receiving a broadcast frame or a configuration response frame that includes access identification information generated by a first device and that is sent by a second device; and identifying the second device according to the access identification information and associating with the second device. In the embodiments of the present invention, the first device identifies a matched second device according to the access identification information, and then may directly associate with the second device, thereby avoiding a process of selecting a correct second device from multiple second devices, simplifying a process for the first device to join a WLAN in which the second device is located, and also making an operation by a user simpler.

This application is a continuation of International Application No. PCT/CN2013/088282, filed on Dec. 2, 2013, which claims priority to Chinese Patent Application No. 201210512787.0, filed on Dec. 4, 2012 and Chinese Patent Application No. 201310066343.3, filed on Feb. 28, 2013, all of which are hereby incorporated by reference in their entireties.

### TECHNICAL FIELD

Embodiments of the present invention relate to communications technologies, and in particular, to a device association method, apparatus, and system.

### BACKGROUND

With the development of network technologies, wireless fidelity (Wireless Fidelity, Wi-Fi for short) networks become increasingly popular, and a growing number of wireless network devices are used.

In the prior art, many users who have set up wireless networks do not configure any security parameter, which makes the networks very vulnerable, and for this reason, the Wi-Fi Alliance has introduced a Wi-Fi protected setup (Wi-Fi protected setup, WPS for short) standard, which is also referred to as Wi-Fi simple configuration (Wi-Fi Simple Configuration, WSC for short); and the purpose of the standard is to simplify operations when a user sets up a wireless local area network (Wireless Local Area Network, WLAN for short), so that the user simply and conveniently sets up a secure WLAN and can conveniently add a device to the WLAN. Specifically, a WPS architecture may be formed by three parts: an access point (Access Point, AP for short), a registrar (Registrar), and a wireless terminal. The registrar is an entity that has the authority to issue and revoke a credential, and may be integrated into the AP or an application terminal, or used as an independent device. The registrar can interact with the AP to implement creation of a WLAN, and subsequently the registrar, the AP, and the wireless terminal may perform interaction to enable the wireless terminal to join the WLAN. A WLAN with an access point is referred to as an infrastructure network, and is referred to as a basic service set (Basic Service Set, BSS for short) network for short in the Institute of Electrical and Electronics Engineers (Institute of Electrical and Electronics Engineers, IEEE for short) 802.11 standard. The existing WPS standard may also be slightly modified for use in a peer-to-peer (Peer-to-Peer, P2P for short) Wi-Fi network, for example, an independent basic service set (Independent Basic Service Set, IBSS for short) network defined in the IEEE 802.11 or a P2P, that is, Wi-Fi Direct, network formulated by the Wi-Fi Alliance.

In the prior art, in a WPS architecture with an AP, when a wireless terminal needs to join a WLAN, the wireless terminal may discover multiple APs, and especially, the names of these APs may be similar or the same; therefore, a user needs to spend time on confirming which AP is the AP that the wireless terminal of the user needs to access, select the AP from a list of these APs, and then initiate subsequent access, or some users does not even clearly know how to select a correct AP, thereby resulting in time consuming and complex operations for the user in a process in which the wireless terminal joins the WLAN. The inventor further finds that in another similar scenario in the prior art, if one device needs to request a connection to another device, a user needs to select the correct another device from multiple devices, and operations of the user in this process are also time consuming and complex.

### SUMMARY

Embodiments of the present invention provide a device association method, device, and system, so as to simplify, during association between one device and another device, an operation by a user in a process of selecting the correct another device from multiple devices.

According to a first aspect, a method for configuring device access is provided, including:

receiving a broadcast frame or a configuration response frame that includes access identification information generated by a first device and that is sent by a second device; and

identifying the second device according to the access identification information, and associating with the second device.

According to the first aspect, in a first possible implementation manner of the first aspect, before the receiving a broadcast frame or a configuration response frame that includes access identification information generated by a first device and that is sent by a second device, the method further includes:

generating the access identification information, so that the access identification information is input into the second device, or the access identification information is input into a registrar and then the registrar sends the access identification information to the second device.

According to the first possible implementation manner of the first aspect, in a second possible implementation manner of the first aspect, the generating the access identification information includes:

randomly generating the access identification information, or

generating the access identification information according to a personal identification number PIN.

According to any one of the first aspect to the second possible implementation manner of the first aspect, in a third possible implementation manner of the first aspect, after the associating with the second device, the method further includes:

receiving a credential sent by the second device; and

joining, according to the credential, a wireless local area network in which the second device is located.

According to a second aspect, a device association method is provided, including:

receiving access identification information generated by a first device; and

sending a broadcast frame or a configuration response frame that includes the access identification information, so that the first device performs identification and association according to the access identification information.

According to the second aspect, in a first possible implementation manner of the second aspect, the receiving access identification information generated by a first device includes:

receiving the access identification information generated by the first device and input by a user; or

receiving a set selected registrar message SSR that includes the access identification information and that is sent by a registrar, where the access identification information is generated by the first device and is input by the user into the access identification information of the registrar.

According to the first possible implementation manner of the second aspect, in a second possible implementation manner of the second aspect, after the sending a broadcast frame or a configuration response frame that includes the access identification information, the method further includes:

sending a credential to the first device, so that the first device joins a wireless local area network according to the credential.

According to the second possible implementation manner of the second aspect, in a third possible implementation manner of the second aspect, the sending a credential to the first device includes:

receiving a credential sent by the registrar, and sending the credential to the first device.

According to a third aspect, a device association method is provided, including:

obtaining a personal identification number PIN and access identification information that are of a first device and input by a user, where the access identification information is generated by the first device;

sending a set selected registrar message SSR that includes the access identification information to a second device, so that the second device sends a broadcast frame or a configuration response frame that includes the access identification information to the first device, and the first device identifies the second device according to the access identification information and associates with the second device.

According to the third aspect, in a first possible implementation manner of the third aspect, the device association method further includes:

sending a credential to the second device, so that the second device sends the credential to the first device, and the first device joins, according to the credential, a wireless local area network in which the second device is located.

According to a fourth aspect, a device is provided, where the device is a first device, including:

a receiving module, configured to receive a broadcast frame or a configuration response frame that includes access identification information generated by the first device and that is sent by a second device; and

an associating module, configured to identify the second device according to the access identification information, and associate with the second device.

According to the fourth aspect, in a first possible implementation manner of the fourth aspect, the device further includes:

a generating module, configured to generate the access identification information, so that the access identification information is input into the second device, or the access identification information is input into a registrar and then the registrar sends the access identification information to the second device; and therefore, the second device sends the broadcast frame or the configuration response frame that includes the access identification information to the first device.

According to the first possible implementation manner of the fourth aspect, in a second possible implementation manner of the fourth aspect, the generating module is specifically configured to randomly generate the access identification information or generate the access identification information according to a personal identification number PIN.

According to any one of the fourth aspect to the second possible implementation manner of the fourth aspect, in a third possible implementation manner of the fourth aspect, the receiving module is further configured to: after the first device associates with the second device, receive a credential sent by the second device; and

the device further includes an access module, configured to join, according to the credential, a wireless local area network in which the second device is located.

According to a fifth aspect, a device is provided, where the device is a second device, including:

a receiving module, configured to receive access identification information generated by a first device; and

a sending module, configured to send a broadcast frame or a configuration response frame that includes the access identification information, so that the first device identifies the second device according to the access identification information and associates with the second device.

According to the fifth aspect, in a first possible implementation manner of the fifth aspect, the receiving module is specifically configured to receive the access identification information generated by the first device and input by a user; or specifically configured to receive a set selected registrar message SSR that includes the access identification information and that is sent by a registrar, where the access identification information is generated by the first device and is input by the user into the access identification information of the registrar.

According to the first possible implementation manner of the fifth aspect, in a second possible implementation manner of the fifth aspect,

the sending module is further configured to send a credential to the first device, so that the first device joins, according to the credential, a wireless local area network in which the second device is located.

According to the second possible implementation manner of the fifth aspect, in a third possible implementation manner of the fifth aspect, the credential specifically is a credential sent by the registrar, and the receiving module is further configured to: after the sending module sends the broadcast frame or the configuration response frame that includes the access identification information, receive the credential sent by the registrar.

According to a sixth aspect, a registrar is provided, including:

a receiving module, configured to receive a personal identification number PIN and access identification information that are input by a user, where the access identification information is generated by a first device; and

a sending module, configured to send a set selected registrar message SSR that includes the access identification information to a second device, so that the second device sends a broadcast frame or a configuration response frame that includes the access identification information to the first device, and the first device identifies the second device according to the access identification information and associates with the second device.

In a first implementation manner according to the sixth aspect, the sending module is further configured to send a credential to the second device, so that the second device sends the credential to the first device, and the first device joins, according to the credential, a wireless local area network in which the second device is located.

According to a seventh aspect, a device association system is provided, including:

the first device provided in the fourth aspect;

the second device provided in the fifth aspect; and

the registrar provided in the sixth aspect.

In the embodiments of the present invention, a first device generates access identification information, the access identification information is directly input into a second device or the access identification information is input into a registrar, the registrar sends the access identification information to the second device, the second device then adds the access identification information to a broadcast frame or a configuration response frame, and the first device identifies very easily, according to the access identification information in the broadcast frame or the configuration response frame, the second device that needs to be connected, and directly associates (Association) with the second device, thereby avoiding a process in which a user needs to select a correct second device from multiple second devices, simplifying a process for the first device to join a wireless local area network in which the second device is located, and further simplifying an operation by the user, which saves time of the user and improves user experience.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic flowchart of Embodiment 1 of a device association method according to the present invention;

FIG. 2 is a schematic flowchart of Embodiment 1 of another device association method according to the present invention;

FIG. 3 is a schematic flowchart of Embodiment 1 of another device association method according to the present invention;

FIG. 4 is a schematic flowchart of Embodiment 1 of another device association method according to the present invention;

FIG. 5 is a schematic structural diagram of Embodiment 1 of a device according to the present invention;

FIG. 6 is a schematic structural diagram of Embodiment 2 of a device according to the present invention;

FIG. 7 is a schematic structural diagram of Embodiment 1 of another device according to the present invention;

FIG. 8 is a schematic structural diagram of Embodiment 1 of a registrar according to the present invention;

FIG. 9 is a schematic structural diagram of Embodiment 1 of a device association system according to the present invention;

FIG. 10 is a schematic structural diagram of Embodiment 1 of another device according to the present invention;

FIG. 11 is a schematic structural diagram of Embodiment 1 of another device according to the present invention; and

FIG. 12 is a schematic structural diagram of Embodiment 1 of another registrar according to the present invention.

### DETAILED DESCRIPTION OF ILLUSTRATIVE EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

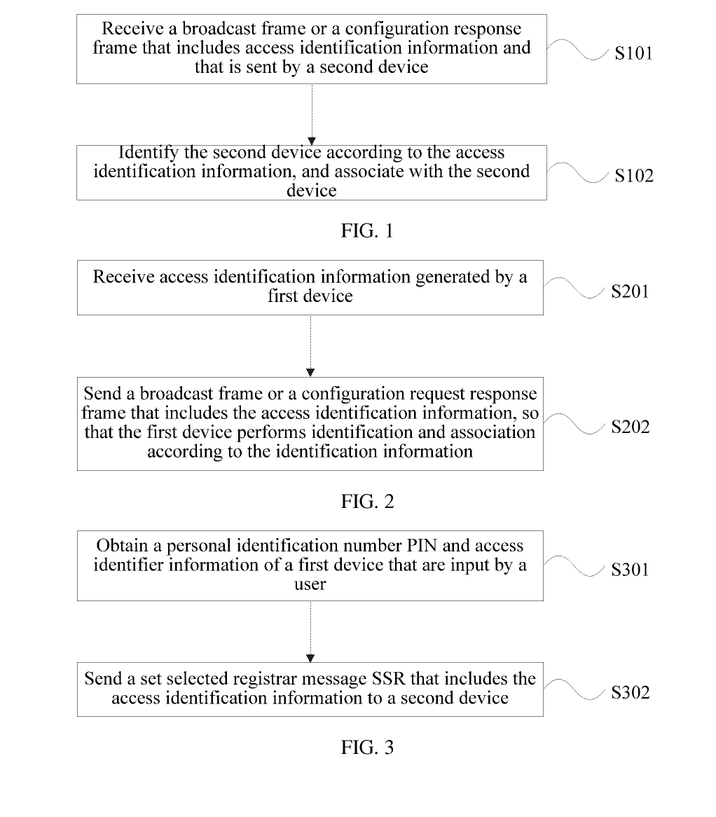

FIG. 1 is a schematic flowchart of Embodiment 1 of a device association method according to the present invention, and as shown in FIG. 1, the method includes:

S101: Receive a broadcast frame or a configuration response frame that includes access identification information and that is sent by a second device, where the access identification information is generated by a first device.

S102: Identify the second device according to the access identification information, and associate with the second device.

The access identification information is generated by the first device, read and then input into a registrar by a user, and transmitted to the second device by using the registrar. In a specific implementation process, the second device may notify the first device of the access identification information in two manners: In one manner, the access identification information is added to a broadcast frame and sent, where the broadcast frame may be a beacon frame sent in a broadcast form. In the other manner, the first device sends a configuration request to the second device, and when making a reply to the configuration request, the second device adds the access identification information to a configuration response frame.

In a specific implementation process, the device association method provided in this embodiment is specifically in two scenarios. One scenario is a scenario for associating a device in the WPS standard, and in this case, the first device may be a wireless terminal, for example, a mobile phone, a tablet computer, a personal digital assistant (Personal Digital Assistant, PDA), or a wireless printer that has a wireless function, and the second device may be an access point, for example, a wireless router. The other scenario is a scenario for associating a device in the peer-to-peer (peer-to-peer, P2P for short) standard, and in this case, the first device and the second device may both be wireless terminals. For example, the two wireless terminals may be directly interconnected (for example, Wi-Fi Direct) in a peer-to-peer (P2P) form, and in this case, the registrar may be integrated into the second device.

In the WPS standard, the registrar in this embodiment may be a registration apparatus in the WPS standard, and is configured to manage establishment of a network and addition or deletion of a wireless terminal for a WLAN on which a wireless access point (that is, the second device in this embodiment) associated with the registrar is located. In a possible implementation manner, the registrar and the second device are separately integrated into two independent devices, where the second device is a wireless access point in an infrastructure-based wireless local area network. For example, the registrar may be integrated into another external device such as a wireless terminal or a computer, and the second device may be integrated into a wireless switch, and may also be an independent device. In another possible implementation manner, the registrar is integrated into the second device, that is, is built in the second device, where the second device is a wireless access point in the infrastructure-based wireless local area network. In the two possible implementation manners, the registrar may manage the second device, and may further discover a wireless terminal that requests to associate with the second device. The first device in this embodiment is a wireless terminal that intends to associate with the second device.

The registrar and the second device in this embodiment are separately integrated into two independent devices, and the registrar may be integrated into another intelligent terminal, to implement the function of the registrar by using the intelligent terminal, so that the second device may only have a wireless access function, the design is simple, and the cost is low. The registrar in this embodiment may further be integrated into the second device, so that the second device further has the function of the registrar, and another device is not required, which makes use by the user convenient. A person skilled in the art may understand that, in a specific implementation process, a suitable implementation manner may be selected according to an actual case and respective advantages of the foregoing two implementation manners.

In the P2P standard, two wireless terminals are not connected through a wireless access point, and instead, establish a connection in a direct connection manner. Specifically, in a process of establishing an interconnection between two wireless terminals in the P2P standard, after discovering each other, the two wireless terminals perform negotiation according to respective computing capabilities, bandwidths, and whether or not having a function of a wireless access device, and finally determine one of the wireless terminals as a group owner in a non-infrastructure-based wireless local area network according to a negotiation result, and use the determined wireless signal as the second device. A person skilled in the art may understand that, in this case, the second device is the group owner in the non-infrastructure-based wireless local area network, and the other wireless terminal is a client in the non-infrastructure-based wireless local area network, and is used as the first device. A person skilled in the art may understand that, two wireless terminals may further be set to directly determine a group owner and a client. Specially, the registrar is further integrated into the second device, and the second device has the function of the registrar. In this embodiment, the second device may be the group owner in the non-infrastructure-based wireless local area network, and the first device may be the client in the non-infrastructure-based wireless local area network, so that the association method in this embodiment may also be applied in the scenario in the P2P standard.

A person skilled in the art may understand that wireless local area networks include an infrastructure-based wireless local area network and a non-infrastructure-based wireless local area network. The infrastructure-based wireless local area network specifically may refer to a wireless local area network that has a wireless access point, and the non-infrastructure-based wireless local area network specifically may refer to a wireless local area network that has no wireless access point.

It should be noted that, in the embodiment of the present invention, the access identification information may be formed by several characters such as digits or letters, and in a setting process, more characters such as digits or letters indicate a better identification effect, but input by the user becomes less convenient. The access identification information may also be one character such as a digit or a letter, and in this way, input is easy, while an identification effect is slightly less desirable. Optionally, in the embodiment of the present invention, the access identification information may be set to be of two or three characters such as digits or letters.

It should be further noted that, in the embodiment of the present invention, the access identification information may be a character such as a digit or a letter, which is independent of a personal identification number (Personal Identification Number, PIN for short) described in the following, and may also be generated by calculating the PIN in a manner, that is, generated according to the PIN. In the former case, the first device may randomly generate the access identification information that is independent of the PIN, and then the user inputs the PIN and the access identification information in the registrar; and in this case, the access identification information is independent of the PIN, and therefore security can be further improved. In the latter case, there may be two implementation manners: In one manner, the user may only need to input the PIN of the first device into the registrar, and after obtaining the PIN, the registrar generates the access identification information by using the PIN, that is, obtains the access identification information, so that the information input by the user does not increase on the basis of the existing WPS standard. In the other manner, the first device generates the access identification information by using the PIN, and then the user inputs the PIN and the access identification information in the registrar. Alternatively, the access identification information may also be obtained by making a calculation on the PIN and a small number of characters such as digits or letters that are independent of the PIN. For example, a user inputs a PIN that has eight digits and two more digits, and then a device calculates, on the basis of the ten digits by using an algorithm, access identification information that has three digits. The access identification information may be generated and obtained in multiple manners, and this is not limited in the embodiment of the present invention.

In a specific application scenario, at least one second device exists, and therefore, after receiving a broadcast frame of the at least one second device, or after sending a configuration request frame, the first device receives a configuration response frame sent by the at least one second device for the configuration request frame, and then by comparing the access identification information included in the received broadcast frame or configuration response frame with the access identification information generated by the first device, the first device filters the at least one received broadcast frame or configuration response frame, so as to identify a matched second device required by the first device, and further associate (Association) with the second device, so that the first device finally obtains a credential (Credential) for joining a wireless local area network in which the second device is located.

In the embodiment of the present invention, by using the access identification information, the first device can very easily identify a matched second device required by the first device, and then may directly perform an operation of associating with the second device, thereby avoiding a process for a user to make a selection from a list that includes information about multiple devices, also simplifying a process for the first device to join the WLAN in which the second device is located, making an operation by the user simpler, and improving user experience.

It should be noted that, before receiving the broadcast frame or the configuration response frame that includes the access identification information generated by the first device and is sent by the second device, the first device generates the access identification information, so that the access identification information is input into the second device, where this case indicates that the registrar is integrated into the second device; or, so that after the access identification information is input into the registrar, the registrar sends the access identification information input by the user to the second device, and then the second device may add the access identification information to a broadcast frame or a configuration response frame that needs to be sent, so that the first device determines, according to the received broadcast frame or configuration response frame, whether the second device is the second device required by the first device.

More specifically, in an embodiment of the present invention, the first device may randomly generate the access identification information, and may also generate the access identification information according to a rule, for example, generate the access identification information according to the personal identification number PIN, where the PIN may be a dynamic PIN or a static PIN, where the dynamic PIN may be randomly generated by the first device every time, and the static PIN may be provided on a device label of the first device by a manufacturer upon delivery of the first device.

Therefore, two cases exist for the generation of the access identification information: In one case, the access identification information is generated when the first device dynamically generates the PIN. In the other case, when the static PIN exists, the access identification information is independently generated.

In addition, after successfully associating with the second device, the first device further executes a process of an Extensible Authentication Protocol (Extensible Authentication Protocol, EAP for short) verification with the second device and the registrar to verify whether a PIN number is correct, receives the credential sent by the second device after the EAP verification succeeds, and joins, according to the credential, the wireless local area network WLAN in which the second device is located, where the credential may be generated by the registrar, and then forwarded by the second device. Specifically, after obtaining the credential, the first device may further send a reply message to the second device, and then the first device has obtained a configuration performed by the second device on the first device and the first device may join the WLAN in which the second device is located.

In the embodiment of the present invention, a first device can very easily identify, according to access identification information generated by the first device, a second device to which the first device intends to be connected, and then may directly perform an operation of associating with the second device, thereby avoiding a process for a user to make a selection from a list that includes information about multiple devices, and next the first device may join, according to an obtained credential, a WLAN in which the second device is located, also simplifying a process for the first device to join the WLAN in which the second device is located, making an operation by the user simpler, simplifying the operation by the user, and improving user experience.

FIG. 2 is a schematic flowchart of Embodiment 1 of another device association method according to the present invention, and as shown in FIG. 2, the method includes:

S201: Receive access identification information generated by a first device. In a specific implementation process, the access identification information generated by the first device and input by a user may be received; or a set selected registrar message (Set selected registrar, SSR for short) that includes the access identification information and that is sent by a registrar may be received, where the access identification information is generated by the first device and is input by the user into the access identification information of the registrar.

S202: Send a broadcast frame or a configuration response frame that includes the access identification information, so that the first device performs identification and association according to the access identification information.

More specifically, the access identification information is generated by the first device, and may be input by the user into the registrar, the registrar adds the access identification information to the SSR and sends the SSR to the second device, and the second device may add the access identification information to a broadcast frame and send the broadcast frame in a broadcast form, so that the first device can receive the broadcast frame. Alternatively, if the second device receives a configuration request frame sent by the first device, the second device may add the access identification information to the configuration response frame and send the configuration response frame to the first device. By comparing the access identification information included in at least one received broadcast frame or configuration response frame with the access identification information generated by the first device, the first device filters the at least one received broadcast frame or configuration response frame including the access identification information, so as to identify a matched second device required by the first device and further directly associate with the second device.

In a specific implementation process, after the second device has successfully associated with the first device, the first device may further execute a process of an EAP verification with the second device and the registrar, to verify whether a PIN number is correct. Specifically, in an embodiment, after the EAP verification succeeds, the second device sends a credential to the first device, so that the first device may join, according to the credential, the wireless local area network WLAN in which the second device is located. In a specific implementation process, the second device may receive the credential sent by the registrar first, and then send the credential to the first device.

In the embodiment of the present invention, by determining, according to access identification information generated by a first device, access identification information included in a broadcast frame or a configuration response frame sent by a second device, the first device very easily identifies a matched second device, and then may directly associate with the second device, and join a WLAN in which the second device is located, thereby avoiding a process for a user to make a selection from multiple second devices, also simplifying a process for the first device to join the WLAN in which the second device is located, and making an operation by the user simpler.

FIG. 3 is a schematic flowchart of Embodiment 1 of another device association method according to the present invention, and as shown in FIG. 3, the method includes:

S301: Obtain a personal identification number PIN and access identification information that are of a first device and input by a user, where the access identification information is generated by the first device.

S302: Send a set selected registrar message SSR that includes the access identification information to a second device, so that the second device sends a broadcast frame or a configuration response frame that includes the access identification information to the first device, and the first device identifies the second device according to the access identification information and associates with the second device.

Specifically, a user may input, into a registrar, the access identification information generated by the first device and a dynamic PIN that is generated at the same time or a static PIN that already exists, where an input sequence is not limited, and the access identification information may be input before or after the PIN is input. By using input of 10 digits as an example, the first 8 digits may be used as the PIN, and the last 2 digits may be used as the access identification information. The 10 digits may be input at a time, or the first 8 digits and the last 2 digits may also be input separately at two times. In addition, only the PIN may be input into the registrar, and the registrar generates the access identification information according to the input PIN, that is, obtains the access identification information. The registrar adds the access identification information to the set selected registrar message SSR that is to be sent to the second device, and after receiving the SSR, the second device adds the access identification information in the SSR to a broadcast frame or a configuration response frame and sends the broadcast frame or the configuration response frame to the first device. In a specific implementation process, one attribute (Attribute) that indicates the access identification information may be added to a WSC information element (Information Element, IE for short), and then the WSC may be added to the SSR sent by the registrar and the broadcast frame or the configuration response frame sent by the second device.

After the first device receives at least one broadcast frame or configuration response frame that includes the access identification information, by comparing the access identification information included in the at least one received broadcast frame or configuration response frame with the access identification information generated by the first device, the first device filters the at least one received broadcast frame or configuration response frame including the access identification information, so as to identify the second device that is required by the first device and has the matching access identification information, and further associate with the second device.

After the second device has successfully associated with the first device, the first device further executes a process of an EAP verification with the second device and the registrar, to verify whether a PIN number is correct. After the EAP verification succeeds, the registrar sends a credential to the second device, so that the second device sends the credential to the first device, and the first device joins, according to the credential, a wireless local area network WLAN in which the second device is located. The credential sent by the registrar may be generated by the registrar according to the PIN input by the user.

In the embodiment of the present invention, a user inputs access identification information generated by a first device into a registrar, and the registrar sends an SSR that includes the access identification information to a second device, so that the second device sends a broadcast frame or a configuration response frame that includes the access identification information to the first device, and the first device very easily identifies a matched second device according to the access identification information, and further may directly associate with the second device, thereby avoiding a process for the user to select a second device required by the first device from multiple second devices found through scanning or searching, also simplifying a process for the first device to join a WLAN in which the second device is located, and making an operation by the user simpler.

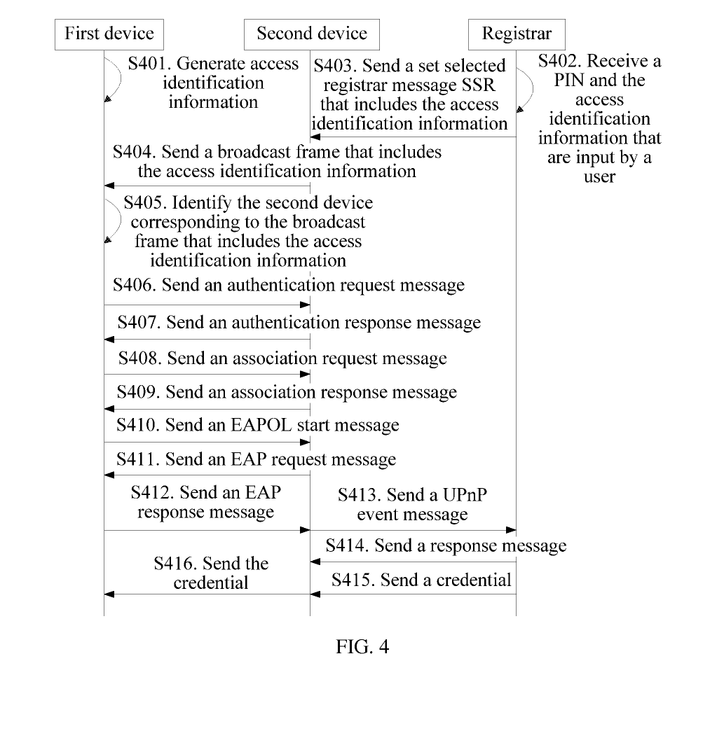

FIG. 4 is a schematic flowchart of Embodiment 1 of another device association method according to the present invention, and as shown in FIG. 4, on the basis of the device association method shown in FIG. 1 to FIG. 3, in a scenario in which a first device receives a broadcast frame sent by a second device, an entire work procedure in the embodiment of the present invention is as follows:

S401: A first device generates access identification information.

Specifically, the first device may generate the access identification information according to a personal identification number PIN. The PIN may be a dynamic PIN, and may also be a static PIN.

If the dynamic PIN is used, when the dynamic PIN is generated, the access identification information may be generated according to the PIN at the same time.

S402: A registrar receives a PIN and the access identification information that are input by a user. It should be noted that, in a specific implementation process, optionally, if the user does not input the PIN and the generated access identification information into the registrar within a time range, the access identification information may be considered expired and needs to be generated again. If a dynamic PIN is used, the dynamic PIN also expires, and needs to be generated again together with the access identification information.

S403: The registrar sends a set selected registrar message SSR that includes the access identification information to a second device.

S404: The second device sends a broadcast frame that includes the access identification information to the first device.

S405: In at least one received broadcast frame, the first device identifies, according to the access identification information generated by the first device, a second device corresponding to the broadcast frame that includes the access identification information.

S406: The first device sends an authentication request message to the second device.

S407: The second device sends an authentication response message to the first device.

S408: The first device sends an association request message to the second device.

S409: The second device sends an association response message to the first device, that is, the first device associates with the second device successfully.

S410: The first device sends an EAPOL (Extensible Authentication Protocol Over Lan, EAPOL for short, Extensible Authentication Protocol Over Lan) start message to the second device.

S411: The second device sends an EAP (Extensible Authentication Protocol, EAP for short, Extensible Authentication Protocol) request message to the first device.

S412: The first device sends an EAP response message to the second device.

S413: The second device sends a Universal Plug-n-Play (Universal Plug-n-Play, UPnP for short) event message to the registrar.

S414: The registrar sends a response message to the second device.

It should be noted that, after the first device associates with the second device successfully, a process of an EAP verification is executed between the first device, the second device, and the registrar and S410 to S414 are content of the specific process of EAP verification; however, the present invention is not limited thereto. After the EAP verification succeeds, the registrar sends a credential to the second device, and then the second device sends the credential to the first device.

S415: The registrar sends a credential to the second device. The credential may also be included in the response message sent by the registrar to the second device.

S416: The second device sends the credential to the first device. The credential may be included in one piece of EAP request information, and sent by the second device to the first device.

After receiving the credential, the first device associates with the second device again, and then may join a WLAN in which the second device is located.

In a scenario in which the first device sends a configuration request to the second device, S404 may be replaced with that, the first device sends a configuration request to at least one second device, and after receiving the configuration request, the at least one second device sends a configuration response frame to the first device, where after receiving the configuration request, the correct second device sends a configuration response frame that includes the access identification information to the first device. Next, S405 is replaced with that, in the received at least one configuration response frame, the first device identifies, according to the access identification information generated by the first device, the second device corresponding to the configuration response frame that includes the access identification information.

It should be noted that, in a specific implementation process, the entire process may be triggered by the registrar, and may also be triggered by the first device. In other words, the registrar may first activate a PIN configuration manner, and the first device may also first activate the PIN configuration manner. However, this is only a difference in an operation sequence of a user and does not affect the foregoing entire process.

In addition, in an actual application process, the second device and the registrar may also be integrated into one network side device, for example, one device such as a wireless router or a mobile phone that has an input interface, which; however, the present invention is not limited thereto. In this case, the registrar may be understood as one functional entity integrated into the second device, and the registrar is built in the second device.

If the first device identifies at least two broadcast frames or configuration response frames that include same access identification information, the first device may sequentially associate with second devices corresponding to the at least two broadcast frames or configuration response frames, and perform a subsequent verification in the prior art, but the probability is relatively low. By using one random two-digit number between 0 and 99, the probability of two second devices having same access identification information is about 1/10000. Especially, if it is set that generated access identification information expires if the access identification information is not input into the registrar after a period of time, the probability becomes even lower.

In the embodiment of the present invention, a first device generates access identification information, and the access identification information is input into a registrar and sent to a second device, so that a broadcast frame broadcast by the second device includes the access identification information, and the first device very easily finds a matched second device according to the access identification information, and directly associates with the second device, thereby avoiding a process for a user to make a selection from multiple second devices, also simplifying a process for the first device to join the WLAN in which the second device is located, and making an operation by the user simpler.

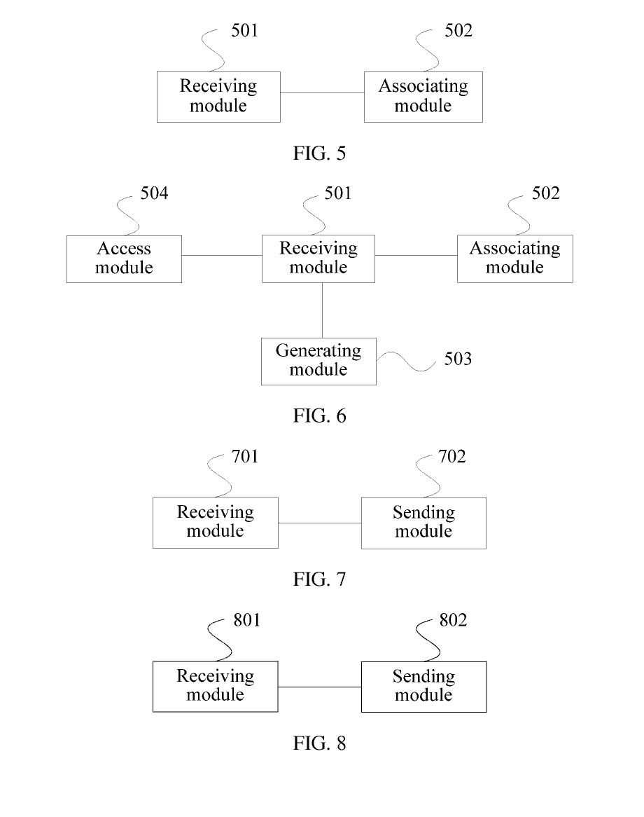

FIG. 5 is a schematic structural diagram of Embodiment 1 of a device according to the present invention, and as shown in FIG. 5, the device corresponds to the first device, and specifically includes a receiving module 501 and an associating module 502, where:

the receiving module 501 is configured to receive a broadcast frame or a configuration response frame that includes access identification information generated by the first device and that is sent by a second device; and

the associating module 502 is configured to identify the second device according to the access identification information, and associate with the second device.

For work of the foregoing modules, refer to the method embodiment shown in FIG. 1, and details are not described herein again.

In the embodiment of the present invention, access identification information that is included in a broadcast frame or a configuration response frame received by a receiving module is generated by a first device, and then is input into a registrar and sent to a second device by a user, and therefore an associating module of the first device very easily identifies the corresponding second device according to the access identification information, and performs association, thereby avoiding a process for the user to make a selection from multiple second devices, also simplifying a process for the first device to join the WLAN in which the second device is located, making an operation by the user simpler, and saving time of the user.

FIG. 6 is a schematic structural diagram of Embodiment 2 of a device according to the present invention, and as shown in FIG. 6, on the basis of FIG. 5, the first device further includes: a generating module 503 and an access module 504, where:

the generating module 503 is configured to generate the access identification information, so that the access identification information is input into the second device, or the access identification information is input into a registrar and then the registrar sends the access identification information to the second device; and therefore, the second device sends the broadcast frame or the configuration response frame that includes the access identification information to the first device.

More specifically, the generating module 503 is configured to randomly generate the access identification information, or generate the access identification information according to a personal identification number PIN.

In addition, the receiving module 501 is further configured to receive a credential sent by the second device; and

the access module 504 is configured to: after the first device associates with the second device, join, according to the credential, a wireless local area network in which the second device is located.

For work processes of the foregoing modules, refer to the method embodiment shown in FIG. 1, and details are not described herein again.

In the embodiment of the present invention, a generating module of a first device generates access identification information, a user reads and then inputs the access identification information into a registrar, and sends the access identification information to a second device, and therefore an associating module of the first device very easily identifies the corresponding second device according to the access identification information, and performs association, thereby avoiding a process for the user to make a selection from multiple second devices, and after the association succeeds, the first device may join, according to a received credential, a WLAN in which the second device is located, thereby also simplifying a process for the first device to join the WLAN in which the second device is located, making an operation by the user simpler, and saving time of the user.

FIG. 7 is a schematic structural diagram of Embodiment 1 of another device according to the present invention, and as shown in FIG. 7, the second device includes: a receiving module 701 and a sending module 702, where,

the receiving module 701 is configured to receive access identification information generated by a first device; and

the sending module 702 is configured to send a broadcast frame or a configuration response frame that includes the access identification information, so that the first device identifies the second device according to the access identification information and associates with the second device.

Further, the receiving module 701 is specifically configured to receive the access identification information generated by the first device and input by a user; or specifically configured to receive a set selected registrar message SSR that includes the access identification information and that is sent by a registrar, where the access identification information is generated by the first device and is input by the user into the access identification information of the registrar.

In a specific implementation process, the sending module 702 is further configured to send a credential to the first device, so that the first device joins, according to the credential, a wireless local area network in which the second device is located. It should be noted that, in an implementation manner, the credential specifically is a credential sent by the registrar, and the receiving module is further configured to: after the sending module sends the broadcast frame or the configuration response frame that includes the access identification information, receive the credential sent by the registrar.

For work processes of the foregoing modules, refer to the method embodiment shown in FIG. 2, and details are not described herein again.

In the embodiment of the present invention, access identification information included in a broadcast frame or a configuration response frame sent by a second device is initially generated and input into a registrar by a first device, and therefore the first device very easily identifies the corresponding second device according to the access identification information, and performs association, thereby avoiding a process for the user to make a selection from multiple second devices, and after the association succeeds, the first device may join, according to a received credential, a WLAN in which the second device is located, thereby also simplifying a process for the first device to join the WLAN in which the second device is located, making an operation by the user simpler, and saving time of the user.

FIG. 8 is a schematic structural diagram of Embodiment 1 of a registrar according to the present invention, and as shown in FIG. 8, the registrar includes: a receiving module 801 and a sending module 802, where,

the receiving module 801 is configured to receive a personal identification number PIN and access identification information that are input by a user, where the access identification information is generated by a first device; and

the sending module 802 is configured to send a set selected registrar message SSR that includes the access identification information to a second device, so that the second device sends a broadcast frame or a configuration response frame that includes the access identification information to the first device, and the first device identifies the second device according to the access identification information and associates with the second device.

In a specific implementation process, after the second device has successfully associated with the first device, the sending module 802 is further configured to send a credential to the second device, so that the second device sends the credential to the first device, and the first device joins, according to the credential, a wireless local area network in which the second device is located.

For work processes of the foregoing modules, reference may be made to the method embodiment shown in FIG. 2, and details are not described herein again.

In the embodiment of the present invention, a user inputs access identification information generated by a first device into a registrar, the registrar sends the access identification information to a second device, the second device broadcasts the access identification information or adds the access identification information to a configuration response frame and returns the configuration response frame to the first device, and the first device very easily identifies the corresponding second device according to the received access identification information, and performs association, thereby avoiding a process for the user to make a selection from multiple second devices, and after the association succeeds, the first device may join, according to a received credential, a WLAN in which the second device is located, thereby also simplifying a process for the first device to join the WLAN in which the second device is located, making an operation by the user simpler, and saving time of the user.

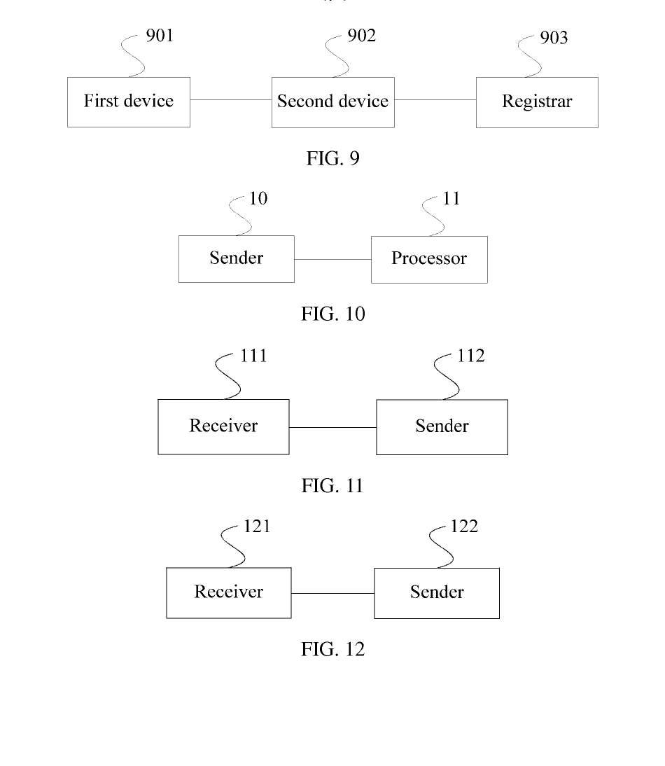

FIG. 9 is a schematic structural diagram of Embodiment 1 of a device association system according to the present invention, and as shown in FIG. 9, the system includes: a first device 901, a second device 902, and a registrar 903, where the first device 901 is the device shown in FIG. 5 and FIG. 6, the second device 902 is the device shown in FIG. 7, the registrar 903 is the registrar shown in FIG. 8, their specific work processes are described in the foregoing, and details are not described herein again.

In the embodiment of the present invention, a first device generates access identification information, and the access identification information is input into a registrar and sent to a second device, so that a broadcast frame or a configuration response frame sent by the second device includes the access identification information, and the first device very easily finds a matched second device according to the access identification information, and directly associates with the second device, thereby avoiding a process for a user to select a second device from multiple second devices, also simplifying a process for a wireless terminal to join a WLAN in which the second device is located, and making an operation by the user simpler.

FIG. 10 is a schematic structural diagram of Embodiment 1 of another device according to the present invention, and as shown in FIG. 10, the device corresponds to the first device, and specifically includes: a receiver 10 and at least one processor 11, where:

the receiver 10 is configured to receive a broadcast frame or a configuration response frame that includes access identification information generated by the first device and that is sent by a second device; and

the processor 11 is configured to identify the second device according to the access identification information, and associate with the second device.

Further, the processor 11 is further configured to generate the access identification information, so that the access identification information is input into the second device, or the access identification information is input into a registrar and then the registrar sends the access identification information to the second device; and therefore, the second device sends the broadcast frame or the configuration response frame that includes the access identification information to the first device.

The processor 11 is specifically configured to randomly generate the access identification information or generate the access identification information according to a personal identification number PIN.

In addition, the receiver 10 is further configured to: after the first device associates with the second device, receive a credential sent by the second device; and the processor 11 is further configured to join, according to the credential, a wireless local area network in which the second device is located.

The device provided in this embodiment may be configured to execute a procedure of the method embodiment shown in FIG. 1 or FIG. 4, and for its specific operating principle, details are not described again, and refer to description of the method embodiment for details.

FIG. 11 is a schematic structural diagram of Embodiment 1 of another device according to the present invention, and as shown in FIG. 11, the device corresponds to the second device, and specifically includes a receiver 111 and a sender 112, where:

the receiver 111 is configured to receive access identification information generated by a first device; and

the sender 112 is configured to send a broadcast frame or a configuration response frame that includes the access identification information, so that the first device identifies the second device according to the access identification information and associates with the second device.

The receiver 111 is specifically configured to receive the access identification information generated by the first device and input by a user; or specifically configured to receive a set selected registrar message SSR that includes the access identification information and that is sent by a registrar, where the access identification information is access identification information that is generated by the first device and is input by the user into the registrar.

Further, the sender 112 is further configured to send a credential to the first device, so that the first device joins, according to the credential, a wireless local area network in which the second device is located. It should be noted that, in an implementation manner, the credential specifically is a credential sent by the registrar, and the receiving module is further configured to: after the sending module sends the broadcast frame or the configuration response frame that includes the access identification information, receive the credential sent by the registrar.

The device provided in this embodiment may be configured to execute a procedure of the method embodiment shown in FIG. 2 or FIG. 4, and for its specific operating principle, details are not described again, and refer to description of the method embodiment for details.

FIG. 12 is a schematic structural diagram of Embodiment 1 of another registrar according to the present invention, and as shown in FIG. 12, the registrar includes: a receiver 121 and a sender 122, where:

the receiver 121 is configured to receive a personal identification number PIN and access identification information that are input by a user, where the access identification information is generated by a first device; and

the sender 122 is configured to send a set selected registrar message SSR that includes the access identification information to a second device, so that the second device sends a broadcast frame or a configuration response frame that includes the access identification information to the first device, and the first device identifies the second device according to the access identification information and associates with the second device.

Further, the sender 122 is further configured to send a credential to the second device, so that the second device sends the credential to the first device, and the first device joins, according to the credential, a wireless local area network in which the second device is located.

It should be noted that, in the embodiment of the present invention, the registrar may be a functional entity, and in an actual application process, the second device and the registrar may also be integrated into one network side device, for example, one device such as a wireless router or a mobile phone that has an input interface, which, however, is not limited thereto. In this case, the registrar may be understood as one functional entity integrated into the second device, and the registrar is built in the second device.

The registrar provided in this embodiment may be configured to execute a procedure of the method embodiment shown in FIG. 3 or FIG. 4, and for its specific operating principle, details are not described again. For details, refer to description of the method embodiment.

It should be noted that, in the foregoing specific embodiments, the implementation processes of the present invention are described according to a network architectures involving three roles, where the first device may be an application terminal that intends to acquire a configuration, the second device may be an access point, the registrar may be a third party device connected to the access point, and the registrar and the access point may communicate with each other in another wireless or wired manner such as a Wi-Fi network or an Ethernet. Actually, the registrar may also be located inside the access point, the user may perform an operation by using one third party device as an input/output interface of the registrar, and in this case, the third party device is connected to the access point in a wired manner. If the registrar is located inside the access point, in the embodiments, the messages between the registrar and the second device may be not required. In another case, the second device and the first device may both be application terminals, the operations on the registrar may actually all be implemented on the second device, the messages between the registrar and the second device are also not required, and in this case, the second device may have already established a wireless local area network with another application terminal, and also may have not established a wireless local area network with another application terminal. In a case in which the second device has not established a wireless local area network with another application terminal, the second device may also be considered as one wireless local area network, and then that the first device joins the wireless local area network in which the second device is located is essentially that the first device and the second device establish a connection and set up a wireless local area network.

It should be further noted that, in the foregoing specific embodiments, when the first device sends the configuration request frame, the access identification information generated by the first device may be included in the configuration request frame, so that after obtaining the access identification information, the second device may determine whether to respond to the received configuration request frame according to the access identification information in the configuration request frame, whether the second device previously obtains the access identification information input by the user or sent by the registrar, and specific content of the obtained access identification information. If the two (the access identification information in the configuration request frame and the previously obtained access identification information) match each other, the second device returns a configuration response frame; otherwise, may skip responding, and further, may further add the obtained access identification information to the configuration response frame. This can prevent the second device from sending an invalid configuration response frame, and can also help to accelerate a configuration and connection process for the first device and the second device.

The broadcast frame in the present invention may be a beacon frame (Beacon) defined in existing Wi-Fi standards, the configuration request frame may be a probe request (probe request) frame, and the configuration response frame may be a probe response (probe response) frame.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A device association method, comprising:
receiving, by a first device, at least one of a broadcast frame or a configuration response frame and that comprises access identification information of the first device and that is sent by a second device, wherein the second device is a wireless access device with which the first device intends to associate, and the access identification information is generated by the first device and that is input by a user into the second device or that is input by the user into a registrar associated with the second device and sent by the registrar to the second device; and
identifying, by the first device, the second device according to the access identification information, and associating with the second device.

2. The method according to claim 1, wherein the access identification information is one of generated randomly by the first device, or generated by the first device according to a personal identification number PIN of the first device.

3. The method according to claim 1, wherein the method further comprises:
receiving, after the associating with the second device, a credential sent by the second device; and
joining, according to the credential, a wireless local area network in which the second device is located.

4. A device association method, comprising:
receiving, by a second device, access identification information of a first device, wherein the second device is a wireless access device with which the first device intends to associate, and wherein the access identification information is generated by the first device and is one of input by a user into the second device or input by the user into a registrar associated with the second device and sent by the registrar to the second device; and
sending, by the second device, a broadcast frame or a configuration response frame that includes the access identification information, so that, after receiving the broadcast frame or the configuration response frame, the first device identifies the second device according to the access identification information and associates with the second device.

5. The method according to claim 4, wherein after the sending a broadcast frame or a configuration response frame that includes the access identification information, the method further comprises:
sending a credential to the first device, so that the first device joins, according to the credential, a wireless local area network in which the second device is located.

6. The method according to claim 5, wherein the sending the credential to the first device comprises:
receiving the credential sent by the registrar, and sending the credential to the first device.

7. The method according to claim 4, wherein the access identification information is at least one of generated randomly by the first device, or generated by the first device according to a personal identification number PIN of the first device.

8. A device association method, comprising:
obtaining, by a registrar, a personal identification number PIN and access identification information that are of a first device and input by a user, wherein the access identification information is generated by the first device; and
sending, by the registrar, the access identification information to a second device associated with the registrar, wherein the second device is a wireless access device with which the first device intends to associate, so that the second device sends a broadcast frame or a configuration response frame that includes the access identification information to the first device, and after receiving the broadcast frame or the configuration response frame, the first device identifies the second device according to the access identification information and associates with the second device.

9. The method according to claim 8, further comprising:
sending a credential to the second device, so that the second device sends the credential to the first device, and the first device joins, according to the credential, a wireless local area network in which the second device is located.

10. The method according to claim 8, wherein the access identification information specifically is at least one of generated randomly by the first device, or generated by the first device according to the personal identification number PIN of the first device.

11. A device, wherein the device is a first device, comprising:
a receiver, configured to receive a broadcast frame or a configuration response frame that comprises access identification information of the first device and that is sent by a second device, wherein the second device is a wireless access device with which the first device intends to associate, and the access identification information is generated by the first device and is input by a user into the second device or is input by the user into a registrar associated with the second device and sent by the registrar to the second device;
a processor connected to the receiver; and
a non-transitory computer readable medium connected to the processor and having stored thereon instructions that, when executed, cause the processor to:
identify the second device according to the access identification information, and associate the first device with the second device.

12. The device according to claim 11, wherein the non-transitory computer readable medium further has stored thereon instructions that, when executed, cause the processor to:
generate the access identification information, wherein the access identification information is generated one of randomly or according to a personal identification number PIN of the first device.

13. The device according to claim 11, wherein the receiver is further configured to receive a credential sent by the second device after the first device associates with the second device; and
the first device further comprises:
an access module, configured to join, according to the credential, a wireless local area network in which the second device is located.

14. A device, wherein the device is a second device, comprising:
a receiver, configured to receive access identification information of a first device, wherein the second device is a wireless access device with which the first device intends to associate, and the access identification information is generated by the first device and is input by a user into the second device or is input by the user into a registrar associated with the second device and sent by the registrar to the second device; and
a transmitter, configured to send a broadcast frame or a configuration response frame that includes the access identification information, so that, after receiving the broadcast frame or the configuration response frame, the first device identifies the second device according to the access identification information and associates with the second device.

15. The device according to claim 14, wherein the transmitter is further configured to send a credential to the first device, so that the first device joins, according to the credential, a wireless local area network in which the second device is located.

16. The device according to claim 15, wherein the credential specifically is a credential sent by the registrar; and
wherein the receiver is further configured to, after the transmitter sends the broadcast frame or the configuration response frame that includes the access identification information, receive the credential sent by the registrar.

17. The device according to claim 14, wherein the access identification information is at least one of generated randomly by the first device, or generated by the first device according to a personal identification number PIN of the first device.

18. A registrar, comprising:
a receiver, configured to receive a personal identification number PIN and access identification information that are of a first device and input by a user, wherein the access identification information is generated by the first device; and
a transmitter, configured to send the access identification information to a second device associated with the registrar, wherein the second device is a wireless access device with which the first device intends to associate, so that the second device sends a broadcast frame or a configuration response frame that includes the access identification information to the first device, and after receiving the broadcast frame or the configuration response frame, the first device identifies the second device according to the access identification information and associates with the second device.

19. The registrar according to claim 18, wherein the transmitter is further configured to send a credential to the second device, so that the second device sends the credential to the first device, and the first device joins, according to the credential, a wireless local area network in which the second device is located.

20. The registrar according to claim 18, wherein the access identification information is at least one of generated randomly by the first device, or is generated by the first device according to the personal identification number PIN of the first device.

21. A device association system, comprising:
a first device comprising:
a first receiver, configured to receive a broadcast frame or a configuration response frame that comprises access identification information of the first device and that is sent by a second device, wherein the second device is a wireless access device with which the first device intends to associate, and the access identification information is generated by the first device and is input by a user into the second device or is input by the user into a registrar associated with the second device and sent by the registrar to the second device; and
a processor connected to the first receiver; and
a non-transitory computer readable medium connected to the processor and having stored thereon instructions that, when executed, cause the processor to:
identify the second device according to the access identification information, and associate the first device with the second device;
a second device comprising:
a second receiver, configured to receive access identification information of a first device, wherein the second device is a wireless access device with which the first device intends to associate, and the access identification information is generated by the first device and is input by a user into the second device or is input by the user into the registrar associated with the second device and sent by the registrar to the second device; and
a first transmitter, configured to send the broadcast frame or the configuration response frame that includes the access identification information, so that after receiving the broadcast frame or the configuration response frame, the first device identifies the second device according to the access identification information and associates with the second device; and
the registrar, comprising:
a third receiver, configured to receive a personal identification number PIN and the access identification information that are of the first device and input by the user; and
a second transmitter, configured to send the access identification information to the second device, so that the second device sends the broadcast frame or the configuration response frame that includes the access identification information to the first device.
